(19) United States
(12) Patent Application Publication
(10) Pub. No.: US 2024/0007274 A1
(43) Pub. Date: Jan. 4, 2024

(54) SECURE COMPUTATION SYSTEM, SECURE COMPUTATION SERVERAPPARATUS, SECURE COMPUTATION METHOD, AND SECURECOMPUTATION PROGRAM

(71) Applicant: NEC Corporation, Minato-ku, Tokyo (JP)

(72) Inventor: Hikaru TSUCHIDA, Tokyo (JP)

(73) Assignee: NEC Corporation, Minato-ku, Tokyo (JP)

(21) Appl. No.: 18/247,055

(22) PCT Filed: Sep. 29, 2020
(86) PCT No.: PCT/JP2020/036931

§ 371 Date: Mar. 28, 2023

(51) Int. Cl. H04L 9/08

(52) U.S. Cl. CPC H04L 9/085; H04L 9/0869

(57) ABSTRACT

A secure computation system comprises at least three secure computation server apparatuses connected to each other via a network, and each of secure computation server apparatuses comprises: a random number generation part that generates a random number for masking an input value; an m-1 bit comparison part that compares a value obtained by removing the most significant bit from input value masked with random number with a value obtained by removing the most significant bit from random number; a carry correction part that corrects calculation of a value obtained by removing the most significant bit from input value on basis of result of comparison; and a most significant bit extraction part that extracts the most significant bit of input value by subtracting corrected value of value obtained by removing the most significant bit from input value from input value.

This application is a National Stage Entry of PCT/JP2020/036931 filed on Sep. 29, 2020, the contents of all of which are incorporated herein by reference, in their entirety.

### FIELD

The present invention relates to a secure computation system, secure computation server apparatus, secure computation method, and secure computation program.

### BACKGROUND

In recent years, the research and development of a technology called secure computation have been active. Secure computation is a technique that executes a predetermined process while keeping the computation process and the results thereof secret from a third party. Multi-party computation is one of the representative techniques of secure computation. In multi-party computation, confidential data is distributed to a plurality of servers (secure computation server apparatuses), and arbitrary computations are executed on the data while secrecy is maintained. Further, the data distributed to each secure computation server apparatus is called a “share.” Hereinafter, the term “secure computation” as used herein refers to multi-party computation, unless otherwise specified.

As one of the secure computation processes, there is a protocol for MSB (Most Significant Bit) extraction. Most significant bit extraction is a protocol for computing the most significant bit of a value from shares of the value distributed among secure computation server apparatuses while confidentiality is maintained. Significant applications of most significant bit extraction include comparison and bit decomposition, and it is important to enhance most significant bit extraction since it will lead to improvements in comparison and bit decomposition as applications thereof.
[Non-Patent Literature 1]
Sameer Wagh, Divya Gupta, and Nishanth Chandran, “SecureNN: 3-Party Secure Computation for Neural Network Training,” Proceedings on Privacy Enhancing Technologies 2019.3 (2019): 26-49.
[Non-Patent Literature 2]
Araki, Toshinori, et al., “How to Choose Suitable Secure Multiparty Computation Using Generalized SPDZ,” Proceedings of the 2018 ACM SIGSAC Conference on Computer and Communications Security, 2018.
[Non-Patent Literature 3]
Araki, Toshinori, et al., “High-Throughput Semi-Honest Secure Three-Party Computation with an Honest Majority,” Proceedings of the 2016 ACM SIGSAC Conference on Computer and Communications Security, 2016.

### SUMMARY

The disclosure of each literature in Citation List above is incorporated herein in its entirety by reference thereto. The following analysis is given by the present inventors.

Since confidential data is processed while being divided and distributed among a plurality of servers in secure computation using the multi-party computation technique, the communication cost must be reduced in order to improve the efficiency of the process. This communication cost can be divided into the communication volume indicating the amount of communicated data and the number of communication rounds indicating the number of communications with maximum parallelization.

Further, while there is often a trade-off between the communication volume and the number of communication rounds, the communication environment may dictate which should be prioritized. For instance, in an environment with a large communication delay such as a WAN (Wide Area Network) environment, secure computation with fewer communication rounds is preferable since it is advantageous to have fewer instances of communication. The most significant bit extraction protocol disclosed in Non-Patent Literature 1, for instance, has constant rounds (10), however, executing most significant bit extraction with smaller constant rounds will benefit applications thereof such as comparison and bit decomposition.

In view of the problem above, it is an object of the present invention to provide a secure computation system, secure computation server apparatus, secure computation method, and secure computation program that contribute to reducing the number of communication rounds in a most significant bit extraction protocol.

According to a first aspect of the present invention, there is provided a secure computation system comprising at least three secure computation server apparatuses connected to each other via a network and extracting the most significant bit of an input value stored while being secret-shared, wherein each of the secure computation server apparatuses comprises: a random number generation part that generates a random number for masking the input value; an m-1 bit comparison part that compares a value obtained by removing the most significant bit from the input value masked with the random number with a value obtained by removing the most significant bit from the random number; a carry correction part that corrects the calculation of a value obtained by removing the most significant bit from the input value on the basis of the result of the comparison; and a most significant bit extraction part that extracts the most significant bit of the input value by subtracting the corrected value of the value obtained by removing the most significant bit from the input value from the input value.

According to a second aspect of the present invention, there is provided a secure computation server apparatus out of at least three secure computation server apparatuses, connected to each other via a network, for extracting the most significant bit of an input value stored while being secret-shared, the secure computation server apparatus comprising: a random number generation part that generates a random number for masking the input value; an m-1 bit comparison part that compares a value obtained by removing the most significant bit from the input value masked with the random number with a value obtained by removing the most significant bit from the random number; a carry correction part that corrects the calculation of a value obtained by removing the most significant bit from the input value on the basis of the result of the comparison; and a most significant bit extraction part that extracts the most significant bit of the input value by subtracting the corrected value of the value obtained by removing the most significant bit from the input value from the input value.

According to a third aspect of the present invention, there is provided a secure computation method for extracting the most significant bit of an input value stored while being secret-shared using at least three secure computation server apparatuses connected to each other via a network, the secure computation method comprising: a random number generation of generating a random number for masking the input value; an m-1 bit comparison of comparing a value obtained by removing the most significant bit from the input value masked with the random number with a value obtained by removing the most significant bit from the random number; a carry correction of correcting a value obtained by removing the most significant bit from the input value on the basis of the result of the comparison; and a most significant bit extraction of extracting the most significant bit of the input value by subtracting the corrected value of the value obtained by removing the most significant bit from the input value from the input value.

According to a fourth aspect of the present invention, there is provided a secure computation program causing at least three secure computation server apparatuses connected to each other via a network extract the most significant bit of an input value stored while being secret-shared, the secure computation program comprising: a random number generation of generating a random number for masking the input value; an m-1 bit comparison of comparing a value obtained by removing the most significant bit from the input value masked with the random number with a value obtained by removing the most significant bit from the random number; a carry correction of correcting the calculation of a value obtained by removing the most significant bit from the input value on the basis of the result of the comparison; and a most significant bit extraction of extracting the most significant bit of the input value by subtracting the corrected value of the value obtained by removing the most significant bit from the input value from the input value. Further, this program can be stored in a computer-readable storage medium. The storage medium may be a non-transient one such as a semiconductor memory, a hard disk, a magnetic recording medium, an optical recording medium, and the like. The present invention can also be realized as a computer program product.

According to each aspect of the present invention, it becomes possible to provide a secure computation system, secure computation server apparatus, secure computation method, and secure computation program that contribute to reducing the number of communication rounds in a most significant bit extraction protocol.

### BRIEF DESCRIPTION OF DRAWINGS

FIG. 1 is a block diagram showing an example of the functional configuration of a secure computation system relating to a first example embodiment.

FIG. 2 is a flowchart showing an outline of the procedure of a secure computation method relating to the first example embodiment.

FIG. 3 is a block diagram showing an example of the functional configuration of a secure computation server apparatus relating to the first example embodiment.

FIG. 4 is a block diagram showing an example of the functional configuration of a secure computation system relating to a second example embodiment.

FIG. 5 is a flowchart showing an outline of the procedure of a secure computation method relating to the second example embodiment.

FIG. 6 is a drawing showing an example of the hardware configuration of the secure computation server apparatus.

### EXAMPLE EMBODIMENTS

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. The dimensional relationships and the ratios between drawings may also be different in some sections.

### [Preparation]

Before example embodiments are described, a notation will be defined and processing elements will be described below. The following notation and computational elements are used in common in the description of each example embodiment.

Parties participating in secure computation are denoted as Pᵢ (i=0, 1, 2). These parties Pᵢ (i=0, 1, 2) are users of secure computation server apparatuses described later, and each can be substantially equated with each secure computation server apparatus.

Let Zₙ be a residue class ring of order n, where n=2^{m}° (m is an integer of 2 or more). Further, let Z₂ be a residue class ring of order 2 and Zp a residue class ring of order p for a prime number p greater than or equal to 3. Note that the residue class ring of order p is a field, but only the properties as a ring are discussed herein.

### [(2, 3)-RSSS]

A 2-out-of-3 replicated secret sharing scheme is configured as follows.

### (For the Residue Class Ring Zₙ of Order n)

If shares over the residue class ring Zₙ for an element x of the residue class ring Zₙ are [x]=([x]₀, [x]₁, [x]₂), then the shares [x]₀, [x]₁, [x]₂ held by the parties Pᵢ (i=0, 1, 2) are defined as follows using x₀, x₁, x₂ such that x=x₀+x₁+x₂ mod n.
[x]₀=(x₀, x₁)
[x]₁=(x₁, x₂)
[x]₂=(x₂, x₀)

When the shares [x]₀, [x]₁, [x]₂ held by the parties Pᵢ (i=0, 1, 2) are defined as above, no party Pᵢ (i=0, 1, 2) is able to reconstruct x from his own share of [x]₀, [x]₁, [x]₂.

### (For the Residue Class Ring Z₂ of Order 2)

If shares over the residue class ring Z₂ for an element x of the residue class ring Z₂ are [x]^{B}=([x]^{B}₀, [x]^{B}₁, [x]^{B}₂), then the shares [x]^{B}₀, [x]^{B}₁, [x]^{B}₂ held by the parties Pᵢ (i=0, 1, 2) are defined as follows using x₀, x₁, x₂ such that x=x₀+x₁+x₂ mod 2.
[x]^{B}₀=(x₀, x₁)
[x]^{B}₁=(x₁, x₂)
[x]^{B}₂=(x₂, x₀)

### (For the Residue Class Ring Zₚ of Order p)

If shares over the residue class ring Zₚ for an element x of the residue class ring Zₚ are [x]^{P}=([x]^{P}₀, [x]^{P}₁, [x]^{P}₂), then the shares [x]^{P}₀, [x]^{P}₁, [x]^{P}₂ held by the parties Pᵢ (i=0, 1, 2) are defined as follows using x₀, x₁, x₂ such that x=x₀+x₁+x₂ mod p.
[x]^{P}₀=(x₀, x₁)
[x]^{P}₁=(x₁, x₂)
[x]^{P}₂=(x₂, x₀)

### [(2, 2)-ASSS]

Further, a 2-out-of-2 additive secret sharing scheme is configured as follows.

If shares over the residue class ring Zₚ for an element x of the residue class ring Zₚ are [[x]]^{P}=([[x]]^{P}₀, [[x]]^{P}₁), then the shares [x]^{P}₀, [x]^{P}₁ held by the parties Pᵢ (i=0, 1) are defined as follows using x₀, x₁ such that x=x₀+x₁ mod p.
[[x]]^{P}₀=x₀
[[x]]^{P}₁=x₁

### [Pseudorandom Function]

A pseudorandom function is a binary operation defined for a security parameter κ. Each party Pᵢ (i=0, 1, 2) holds a seedᵢ ∈{0, 1}^{κ}(i=0, 1, 2) distributed among them such as (seedᵢ, seedᵢ₊₁) (where seed₂₊₁=seed₀), and an identifier vid ∈ {0, 1}K is a public value such as a counter. Pseudorandom functions Fₙ, F₂, Fₚ are the following binary operations receiving these seeds (seedᵢ ∈ {0, 1}κ) and the identifier vid ∈{0, 1}K as inputs.
Fₙ: {0, 1}^{κ}×{0, 1}^{κ}→{0, 1}ⁿ
F₂: {0, 1}^{κ}×{0, 1}^{κ}→{0, 1}²
F_{p*}: {0, 1}^{κ}×{0, 1}^{κ}→Z*ₚ

The following describes computational building blocks used in the example embodiments below, along with the number of communication rounds and the communication volume thereof.

### [Bit Conversion]

Two types of bit conversions are used as building blocks. One is a bit conversion: [x]←BC ([x]^{B}) that obtains a share [x] over the residue class ring Zₙ of order n from a share [x]^{B} over the residue class ring Z₂ of order 2. For instance, the method described in Non-Patent Literature 2 can be used as an actual operation. The bit conversion: [x]←BC ([x]^{B}) has two communication rounds and a communication volume of 6 m bits.

The other is a bit conversion: [x]^{P}←BC ([x]^{B}) that obtains a share [x]^{P} over the residue class ring Zₚ of order p from a share [x]^{B} over the residue class ring Z₂ of order 2. The actual operation is more or less the same as the method described in Non-Patent Literature 2; the difference is the fact that the conversion is made into a share [x]^{P} over the residue class ring Zₚ of order p. The shares [x]^{B} over the residue class ring Z₂ of order 2 are reshared into [x]^{P}₀, [x]^{P}₁, [x]^{P}₂, rather than [x]₀, [x]₁, [x]₂. Then, [x]^{P}=(([x]^{P}₀−[x]^{P}₁)²−[X]^{P}₂)² is computed. The bit conversion: [x]^{P}←BC ([x]^{B}) has two communication rounds and a communication volume of 6 log₂(p) bits.

### [Reconstruction]

Three types of reconstructions are used as building blocks. One is a reconstruction: x←Open (Pᵢ, [x]) in which the parties Pᵢ obtain an element x from shares [x] over a residue class ring Z₂^{m} of order 2^{m} by unlocking the secrecy of x. For instance, the method described in Non-Patent Literature 3 can be used as an actual operation. The reconstruction: x←Open (Pᵢ, [x]) has one communication round and a communication volume of m bits.

The second one is a reconstruction: x←Open (Pᵢ, [x]^{B}) in which the parties Pᵢ obtain an element x from the shares [x]^{B} over the residue class ring Z₂ of order 2 by unlocking the secrecy of x. For instance, the method described in Non-Patent Literature 3 can be used as an actual operation. The reconstruction: x←Open (Pᵢ, [x]^{B}) has one communication round and a communication volume of 1 bit.

The third one is a reconstruction: x←Open (Pᵢ, [x]^{P}) in which the parties Pᵢ obtain an element x from the shares [x]^{P} over the residue class ring Zₚ of order p by unlocking the secrecy of x. The actual operation is more or less the same as, for instance, the method described in Non-Patent Literature 3; the difference is the fact that the reconstruction is performed over the residue class ring Zₚ. The reconstruction: x←Open (Pᵢ, [x]^{P}) has one communication round and a communication volume of log₂(p) bits.

### [Bit Conversion]

A conversion: [[x]]^{P}←SC ([x]^{P}, Pᵢ, Pᵢ₊₁), in which two parties Pᵢ, Pᵢ+i from the parties Pᵢ (i=0, 1, 2) obtain shares in (2, 2)-ASSS from (2, 3)-RSSS, can be performed, for instance, with the two parties being P₀, Pᵢ, when [[x]]^{p}₀=(x₀+x₁) mod p, [[x]]^{P}₁=x₂.

### [Sharing]

Two types of sharing are used as building blocks. One is sharing: [x] ←Share (Pᵢ, x) in which an element x supplied by a party Pᵢ as an input dealer is split and distributed among the parties Pᵢ as the shares [x] over the residue class ring Z₂^{m} of order 2¹°. For instance, the method described in Non-Patent Literature 3 can be used. The sharing: [x] ←Share (Pᵢ, x) has one communication round and a communication volume of 4^{m} bits.

The other is sharing: [x]^{B}←Share (Pᵢ, x) in which an element x supplied by a party Pᵢ as an input dealer is split and distributed among the parties Pᵢ as shares [x] over the residue class ring Z₂ of order 2. For instance, the method described in Non-Patent Literature 3 can be used. The sharing: [x]^{B}←Share (Pᵢ, x) has one communication round and a communication volume of 4 bits.

### [Random Number Generation]

Two types of random number generation are used as building blocks. One is random number generation: [r]←RndGen (seedᵢ, seedᵢ₊₁) that generates a random share [r] over the residue class ring Z₂^{m} of order 2¹° from a pair of seeds (seedᵢ, seedᵢ₊₁) and the identifier vid, and it is defined as [r]; =(Fₙ(seedᵢ, vid), Fₙ (seedᵢ₊₁, vid)) using the pseudorandom function Fₙ described above.

The other is random number generation: [r]^{B}←BitRndGen (seedᵢ, seedᵢ₊₁) that generates a random share [r]^{B} over the residue class ring Z₂ of order 2 from a pair of seeds (seedᵢ, seedᵢ₊₁) and the identifier vid, and it is defined as [r]; =(F₂ (seedᵢ, vid), F₂ (seedᵢ₊₁, vid)) using the pseudorandom function F₂ described above.

### [PrivateCompare]

PrivateCompare is a building block that executes comparison in constant rounds, and for instance, the operations described in Non-Patent Literature 1 can be used. PrivateCompare has one communication round and a communication volume of 2 m log₂(p) bits.

### First Example Embodiment

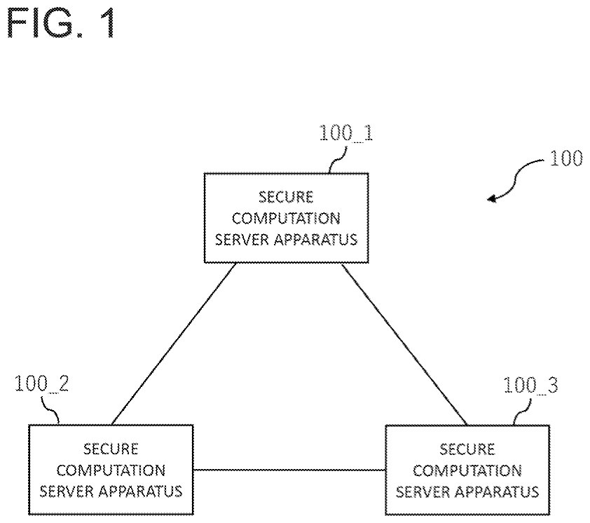

The following describes a secure computation system, secure computation server apparatus, and secure computation method relating to a first example embodiment with reference to FIGS. 1, 2, and 3. The first example embodiment is described as the basic concept of the present invention.

FIG. 1 is a block diagram showing an example of the functional configuration of the secure computation system relating to the first example embodiment. As shown in FIG. 1, the secure computation system 100 according to the first example embodiment comprises a first secure computation server apparatus 100_1, a second secure computation server apparatus 100_2, and a third secure computation server apparatus 100_3. The first, the second, and the third secure computation server apparatuses 100_1, 100_2, and 100_3 are connected to each other via a network so as to be able to communicate with each other.

The secure computation system 100 comprising the first to the third secure computation server apparatuses 100_i (i=1, 2, 3) is able to compute desired shares of a value supplied by any one of the first to the third secure computation server apparatuses 100_i (i=1, 2, 3) as an input while keeping the input value and the values during the computation process secret, and distribute the computation results to the first to the third secure computation server apparatuses 100_i (i=1, 2, 3) to store them therein.

Further, the secure computation system 100 comprising the first to the third secure computation server apparatuses 100_i (i=1, 2, 3) is able to compute desired shares of shares distributed to and stored in the first to the third secure computation server apparatuses 100_i (i=1, 2, 3) while keeping the values during the computation process secret, and distribute the computation results to the first to the third secure computation server apparatuses 100_i (i=1, 2, 3) to store them therein.

Further, the shares that resulted from the computations above may be reconstructed by exchanging the shares with the first to the third secure computation server apparatuses 100_1 to 100_3. Alternatively, the shares may be decoded by transmitting them to an external apparatus, instead of the first to the third secure computation server apparatuses 100_1 to 100_3.

The following describes a problem in performing secure computation that extracts a most significant bit.

First, let us assume that an input value a whose most significant bit is to be extracted is secret-shared and held by the first to the third secure computation server apparatuses 100_i (i=1, 2, 3) as shares [a]. It may also be assumed that, if the input value a whose most significant bit is to be extracted is newly supplied to any one of the first to third secure computation server apparatuses 100_1 to 100_3, any one of the first to third secure computation server apparatuses 100_1 to 100_3 generates the shares [a] to secret-share them.

The purpose of the secure computation is to compute shares [msb(a)] of the most significant bit msb(a) of the input value a from the shares [a], and each of the first to the third secure computation server apparatuses 100_i (i=1, 2, 3) cannot know the input value a from its own share [a] and cannot directly know the most significant bit msb(a).

Therefore, the first to the third secure computation server apparatuses 100_i (i=1, 2, 3) compute the shares [msb(a)] by exchanging information of the shares [a] held therein, however, if the information is exchanged unrestrictedly, the first to the third secure computation server apparatuses 100_i (i=1, 2, 3) will be able to reconstruct the input value a, breaking the secrecy.

In order to avoid this, when the information of the shares [a] is exchanged among the first to the third secure computation server apparatuses 100_i (i=1, 2, 3), the shares may be masked with random numbers so that the information cannot be reconstructed. However, masking with a random number also has a problem; the most significant bit msb(a) may be affected by masking.

In the example embodiments of the present invention, this problem is avoided by verifying whether or not the most significant bit msb(a) is affected by a random mask and correcting any effect on the most significant bit msb(a) caused by a random mask. This technique will be described below by giving an outline of the procedure of the secure computation method relating to the first example embodiment.

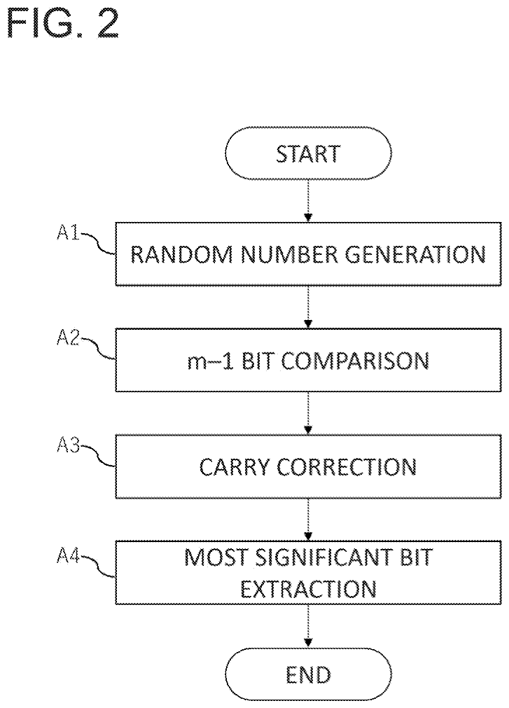

FIG. 2 is a flowchart showing an outline of the procedure of the secure computation method relating to the first example embodiment. The outline of the procedure of the secure computation method shown in FIG. 2 relates to a secure computation method for extracting the shares [msb(a)] of the most significant bit from the secret-shared shares [a] of the input value using the first to the third secure computation server apparatuses 100_i (i=1, 2, 3) connected to each other via a network.

Step A1 is a random number generation step of generating a random share [r] for masking a share [a] of the input value. As described later, a share [a] of the input value is not required to generate a random share [r]. Therefore, this random number generation step does not depend on the input value a, and each of the first to the third secure computation server apparatuses 100_i (i=1, 2, 3) is able to perform this process independently. In other words, the random number generation step can be executed as so-called offline processing.

Step A2 is an m-1 bit comparison step of comparing a value [(a+r) mod 2^{m-1}] obtained by removing the most significant bit from an input value [a+r] masked with the random number [r] with a value [r mod 2^{m-1}] obtained by removing the most significant bit from the random number [r]. This comparison makes it possible to determine whether or not the most significant bit msb(a) is affected by the random mask.

Step A3 is a carry correction step of correcting a value [a mod 2^{m-1}] obtained by removing the most significant bit from the share [a] of the input value on the basis of the result of the comparison in the step A2. As described later, in order to calculate the share [a mod 2^{m-1}], the share [r mod 2^{m-1}] is subtracted from the share [(a+r) mod 2^{m-1}], however, if this calculation is simply performed, the resultant value will be incorrect when carrying is affected by the random mask. Therefore, in the step A3, the calculation of [a mod 2^{m-1}] obtained by removing the most significant bit from the input value is corrected when the value [r mod 2^{m-1}] obtained by removing the most significant bit from the random number [r] is greater than the value [(a+r) mod 2^{m-1}] obtained by removing the most significant bit from the input value [a+r] masked with the random number [r].

Step A4 is a most significant bit extraction step of extracting the share [msb(a)] of the most significant bit of the input value by subtracting the corrected share value [a mod 2^{m-1}] obtained by removing the most significant bit from the input value from the share [a] of the input value.

As described, the secure computation method relating to the first example embodiment is able to correctly extract a most significant bit while maintaining confidentiality with a random mask by verifying whether or not the most significant bit msb(a) is affected by the random mask and correcting any effect on the most significant bit msb(a) caused by the random mask.

Further, as described later with specific numerical values, the secure computation method relating to the first example embodiment is able to limit the number of communication rounds in the processing of each step to constant rounds. Therefore, the secure computation method relating to the first example embodiment is able to contribute to reducing the number of communication rounds in a most significant bit extraction protocol.

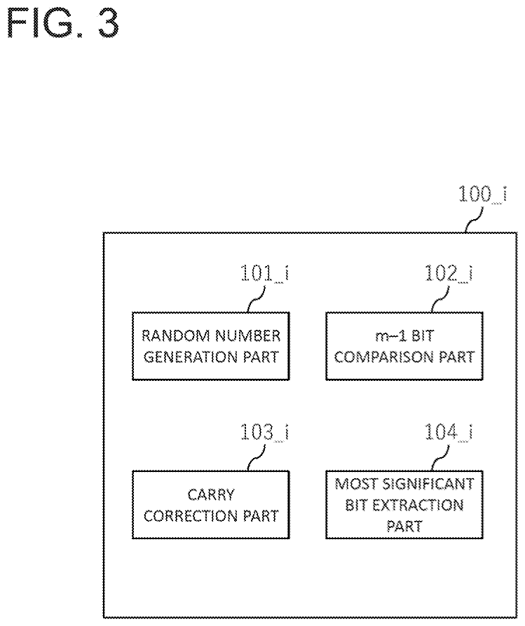

FIG. 3 is a block diagram showing an example of the functional configuration of the secure computation server apparatus relating to the first example embodiment. The example of the functional configuration of the secure computation server apparatus shown in FIG. 3 is suitable for implementing the secure computation method relating to the first example embodiment shown in FIG. 2. It should be noted that the configuration of the secure computation server apparatus capable of implementing the secure computation method relating to the first example embodiment is not limited to the one shown in FIG. 3 and for instance an example of a hardware configuration described in detail later may be employed.

The example of the functional configuration of the secure computation server apparatus shown in FIG. 3 represents one of the first to the third secure computation server apparatuses 100_i (i=1, 2, 3) shown in FIG. 1. As shown in FIG. 3, each of the first to the third secure computation server apparatuses 100_i (i=1, 2, 3) comprises a random number generation part 101_i, an m-1 bit comparison part 102_i, a carry correction part 103_i, and a most significant bit extraction part 104_i.

The random number generation part 101_i is configured to generate a random share [r] for masking a share [a] of an input value. As already pointed out, an input share [a] is not required to generate a random share [r]. Therefore, the random number generation part 101_i does not depend on the input value a, and each of the first to the third secure computation server apparatuses 100_i (i=1, 2, 3) is able to perform processing independently.

The m-1 bit comparison part 102_i is configured to compare the value [(a+r) mod 2^{m-1}] obtained by removing the most significant bit from the input value [a+r] masked with the random number [r] with the value [r mod 2^{m-1}] obtained by removing the most significant bit from the random number [r]. This comparison makes it possible to determine whether or not the most significant bit msb(a) is affected by the random mask.

The carry correction part 103_i is configured to correct the value [a mod 2^{m-1}] obtained by removing the most significant bit from the share [a] of the input value on the basis of the result of the comparison above. The carry correction part 103_i corrects the calculation of [a mod 2^{m-1}] obtained by removing the most significant bit from the input value when the value [r mod 2^{m-1}] obtained by removing the most significant bit from the random number [r] is greater than the value [(a+r) mod 2^{m-1}] obtained by removing the most significant bit from the input value [a+r] masked with the random number [r].

The most significant bit extraction part 104_i is configured to extract the share [msb(a)] of the most significant bit of the input value by subtracting the corrected share value [a mod 2^{m-1}] obtained by removing the most significant bit from the input value from the share [a] of the input value.

As described, the secure computation server apparatus relating to the first example embodiment has a functional configuration suitable for implementing the secure computation method relating to the first example embodiment. In other words, the secure computation server apparatus relating to the first example embodiment comprises a configuration suitable for correctly extracting a most significant bit while maintaining confidentiality with a random mask by verifying whether or not the most significant bit msb(a) is affected by the random mask and correcting any effect on the most significant bit msb(a) caused by the random mask.

Further, the secure computation method implemented by the secure computation server apparatus relating to the first example embodiment is able to limit the number of communication rounds in the processing of each step to constant rounds. Therefore, the secure computation server apparatus relating to the first example embodiment is able to contribute to reducing the number of communication rounds in a most significant bit extraction protocol.

Further, the secure computation system relating to the first example embodiment comprising the secure computation server apparatus relating to the first example embodiment as each of the first to the third secure computation server apparatuses 100_i (i=1, 2, 3) also has a functional configuration suitable for implementing the secure computation method relating to the first example embodiment. In other words, the secure computation server apparatus relating to the first example embodiment comprises a configuration suitable for correctly extracting a most significant bit while maintaining confidentiality with a random mask by verifying whether or not the most significant bit msb(a) is affected by the random mask and correcting any effect on the most significant bit msb(a) caused by the random mask.

In addition, the secure computation method implemented by the secure computation system relating to the first example embodiment is able to limit the number of communication rounds in the processing of each step to constant rounds. Therefore, the secure computation system according to the first example embodiment is able to contribute to reducing the number of communication rounds in a most significant bit extraction protocol.

### Second Example Embodiment

Next, the following describes a second example embodiment in which a concrete example of the secure computation described in the first example embodiment is given. Since a secure computation system, secure computation server apparatus, and secure computation method relating to the second example embodiment are concrete examples of the secure computation described in the first example embodiment, the configurations thereof have a lot in common. Therefore, the descriptions of the configurations are omitted in the second example embodiment as appropriate.

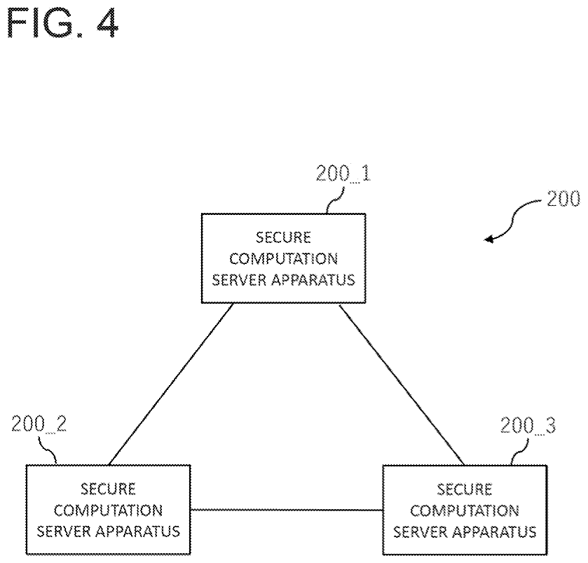

FIG. 4 is a block diagram showing an example of the functional configuration of the secure computation system relating to the second example embodiment. As shown in FIG. 4, the secure computation system 200 according to the second example embodiment comprises a first secure computation server apparatus 200_1, a second secure computation server apparatus 200_2, and a third secure computation server apparatus 200_3. The first, the second, and the third secure computation server apparatuses 200_1, 200_2, and 200_3 are connected to each other via a network so as to be able to communicate with each other.

The secure computation system 200 comprising the first to the third secure computation server apparatuses 200_i (i=1, 2, 3) is able to compute desired shares of shares distributed to and stored in the first to the third secure computation server apparatuses 200_i (i=1, 2, 3) while keeping the values during the computation process secret, and distribute the computation results to the first to the third secure computation server apparatuses 200_i (i=1, 2, 3) to store them therein.

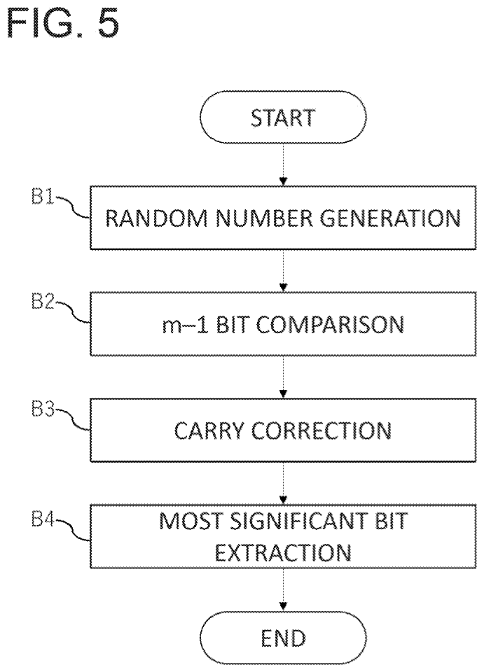

FIG. 5 is a flowchart showing an outline of the procedure of the secure computation method relating to the second example embodiment. The outline of the procedure of the secure computation method shown in FIG. 5 relates to a secure computation method for extracting the shares [msb(a)] of the most significant bit from the secret-shared shares [a] of the input value using the first to the third secure computation server apparatuses 200_i (i=1, 2, 3) connected to each other via a network.

As shown in FIG. 5, the secure computation method relating to the second example embodiment can be broadly divided into the random number generation step (step B1), the m-1 bit comparison step (step B2), the carry correction step (step B3), and the most significant bit extraction step (step B4). The details of each step will be described below.

### [Step B1]

The step B1 is the random number generation step of generating the random shares [r] for masking the shares [a] of the input value.

### (Step B1-1)

Execute the random number generation: [rⱼ]^{B}←BitRndGen (seedᵢ, seedᵢ₊₁) that generates random shares [r]^{B} over the residue class ring Z₂ of order 2 from a pair of seeds (seedᵢ, seedᵢ₊₁) and the identifier vid for j=0, . . . , m-1.

### (Step B1-2)

Execute the bit conversion: [rⱼ]←BC ([rⱼ]¹³) that obtains random shares [rⱼ] over the residue class ring Zₙ of order n from the random shares [rⱼ]^{B} over the residue class ring Z₂ of order 2 for j=0, . . . , m-1.

### (Step B1-3)

Execute the bit conversion: [rⱼ]^{P}←BC ([rⱼ]^{B}) that obtains random shares [rⱼ]^{P} over the residue class ring Zₚ of order p from the random shares [rⱼ]^{B} over the residue class ring Z₂ of order 2 for j=0, . . . , m-1.

### (Step B1-4)

Two parties P₀, Pᵢ perform the conversion: [[r]]^{P}←SC ([rⱼ]^{P}, P₀, Pᵢ) that obtains shares [[r]]p in (2, 2)-ASSS from [rⱼ]^{P} in (2, 3)-RSSS for j=0, . . . , m-1.

### (Step B1-5)

Configure the random shares [r] as follows.

[r]=Σⱼ₌₀^{m-1}2^{j}·[rⱼ] [Math. 1]

### (Step B1-6)

Extract the low order m-1 bit portions of the random shares [r] as follows.

[r mod 2^{m-1}]Σⱼ₌₀^{m-2}2^{j}·[rⱼ] [Math. 2]

### (Step B1-7)

With the most significant bit of the random number r being untouched, calculate a share having the low order m-1 bit portion filled with zeros as follows.

[2^{m-1}msb(r)]=[r−(r mod 2^{m-1})]=2^{m-1}[rₘ₋₁]=2^{m-1}[msb(r)]

The steps B1-1 to B1-7 do not require the shares [a] of the input value. Therefore, the steps B1-1 to B1-7 can be executed as so-called offline processing. Further, the steps B1-1 to B1-7 require two communication rounds and a communication volume of 6 m²+6(m-1)log₂(p).

### [Step B2]

The step B2 is the m-1 bit comparison step of comparing the value [(a+r) mod 2^{m-1}] obtained by removing the most significant bit from the input value [a+r] masked with the random number [r] with the value [r mod 2^{m-1}] obtained by removing the most significant bit from the random number [r].

### (Step B2-1)

Mask the share [a] of the input value whose most significant bit is to be extracted with the random share [r].

[a+r]=[a]+[r]

### (Step B2-2)

Multiply the share [a+r] of the input value masked with the random share [r] by two. In other words, left-shift by one bit to get rid of the most significant bit. Note that the least significant bit becomes zero in this process.

[2((a+r)mod 2^{m-1})]=2[a+r]

### (Step B2-3)

Each party Pᵢ (i=0, 1, 2) extracts only the m-1 bit portion from the m-bit value a+r.

[2((a+r)mod 2^{m-1})←Open(Pᵢ,[2((a+r)mod 2^{m-1})])

### (Step B2-4)

The parties P₀ and P₁ generate β∈{0, 1}, sᵢ∈Z*ₚ, and uᵢ∈Z*ₚ using a pseudorandom function and a seed₁.

### (Step B2-5)

The party P₂ calculates a variable u′ using PrivateCompare as follows.

u′←PrivateCompare((a+r)mod 2^{m-1},{ [symbol] rⱼ [symbol] ^{p}}ⱼ₌₀^{m-2},β,{sᵢ}ⱼ₌₀^{m-2},{uᵢ}ⱼ₌₀^{m-2},P₂) [Math. 3]

### (Step B2-6)

Secret-share the variable u′ calculated by the party P₂ as shares [u′].

### (Step B2-7)

The parties P₀ and Pᵢ configure shares [β] and the shares [(a+r) mod 2^{m-1}] as follows.

[β]=((0,β),(β,0),(0,0))

[(a+r)mod 2^{m-1}]=((0,(a+r)mod 2^{m-1}),((a+r)mod 2^{m-1},0),(0,0))

### (Step B2-8)

The comparison of the value obtained by removing the most significant bit from the input value masked with the random number and the value obtained by removing the most significant bit from the random number can be calculated as follows, and let the share indicating the result thereof be [u]. The share [u] is one when the value obtained by removing the most significant bit from the input value masked with the random number is greater than the value obtained by removing the most significant bit from the random number, and zero otherwise.

[u]=[(r mod 2^{m-1})>((a+r)mod 2^{m-1})]=([u′]−[β])² [Math. 4]

### [Step B3]

The step B3 is the carry correction step of correcting the value [a mod 2^{m-1}] obtained by removing the most significant bit from the share [a] of the input value on the basis of the result of the comparison in the step B2. In order to calculate the share [a mod 2^{m-1}], the share [r mod 2^{m-1}] is subtracted from the share [(a+r) mod 2^{m-1}], however, if this calculation is simply performed, the resultant value will be incorrect when carrying is affected by the random mask. Therefore, in this correction step, the calculation of the share [a mod 2^{m-1}] is corrected using the share [u] indicating the relationship calculated in the step B2.

### (Step B3-1)

Correct the calculation of the share [a mod 2^{m-1}] using the share [u] indicating the relationship calculated in the step B2, as follows.

[a mod 2^{m-1}]=[(a+r)mod 2^{m-1}]−[r mod 2^{m-1}]+2^{m-1}·[u] [Math. 5]

If the value [r mod 2^{m-1}] obtained by removing the most significant bit from the random number [r] is greater than the value [(a+r) mod 2^{m-1}] obtained by removing the most significant bit from the input value [a+r] masked with the random number [r], the calculation above can correct the calculation of the value [a mod 2^{m-1}] obtained by removing the most significant bit from the input value.

As a result of this correction, the m-1 bit portion can be correctly extracted from the m bits of the input value a.

### [Step B4]

The step B4 is the most significant bit extraction step of extracting the share [msb(a)] of the most significant bit of the input value by subtracting the corrected share value [a mod 2^{m-1}] obtained by removing the most significant bit from the input value from the share [a] of the input value.

### (Step B4-1)

Subtract the corrected share value [a mod 2^{m-1}] obtained by removing the most significant bit from the input value from the share [a] of the input value.

[2^{m-1}msb(a)]=[a]−[a mod 2^{m-1}]

### (Step B4-2)

Next, perform the following calculation.

[2^{m-1}·(msb(a)⊕msb(r))]=[2^{m-1}·msb(a)]+[2^{m-1}·msb(r)][Math. 6]

### (Step B4-3)

The party P₀ reconstructs the calculation result in the step B4-2.

2^{m-1}·(msb(a)⊕msb(r))←Open(P₀,[2^{m-1}·(msb(a)⊕msb(r))]) [Math. 7]

### (Step B4-4)

The party P₀ secret-shares the value obtained by dividing the calculation result in the step B4-3 by 2^{m-1}.

[msb(a)⊕msb(r)]^{B}←BitShare(P₀,msb(a)⊕msb(r)) [Math. 8]

### (Step B4-5)

Finally, by performing the following calculation, shares [msb(a)]^{B} of the most significant bit can be extracted.

[msb(a)]^{B}=[msb(a)⊕msb(r)]^{B}⊕[rₘ₋₁]^{B} [Math. 9]

As described, the secure computation method relating to the second example embodiment is able to extract the shares [msb(a)]^{B} of the most significant bit from the shares [a] of the input value.

The secure computation method relating to the second example embodiment has eight communication rounds and a communication volume of 6 m²+8(m−1)log₂(p)+11 m+4 bits in terms of the total communication cost of extracting the shares [msb(a)]^{B} of the most significant bit from the shares [a] of the input value.

Further, as a breakdown of the communication cost, the step B1, which is offline processing, has two communication rounds and a communication volume of 6 m²+6(m−1)log₂(p). The steps B2 to B4, which are online processing, have six communication rounds and a communication volume of 11 m+4+2(m−1)log₂(p).

For instance, the method for extracting a most significant bit described in Non-Patent Literature 1 has ten communication rounds and a communication volume of 8 m log₂(p)+19 m+2 as the communication cost. Therefore, the secure computation method of the present invention can reduce the number of communication rounds in the communication cost, compared with the method for extracting a most significant bit described in Non-Patent Literature 1. In other words, the secure computation method of the present invention is able to contribute to reducing the number of communication rounds in a most significant bit extraction protocol.

### [Hardware Configuration]

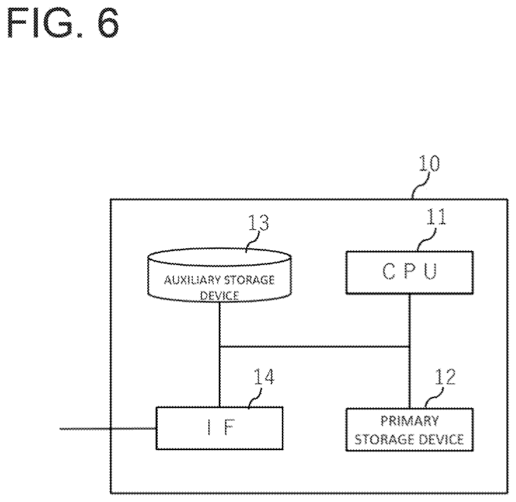

FIG. 6 is a drawing illustrating an example of the hardware configuration of the secure computation server apparatus. In other words, FIG. 6 shows an example of the hardware configuration of the secure computation server apparatuses 100_i and 200_i (i=1, 2, 3). An information processing apparatus (computer) employing the hardware configuration shown in FIG. 6 can achieve the functions of the secure computation server apparatuses 100_i and 200_i (i=1, 2, 3) by executing the secure computation method described above as a program.

It should be noted that the hardware configuration example shown in FIG. 6 is merely an example of the hardware configuration that achieves the functions of the secure computation server apparatuses 100_i and 200_i (i=1, 2, 3), and is not intended to limit the hardware configuration of the secure computation server apparatuses 100_i and 200_i (i=1, 2, 3). The secure computation server apparatuses 100_i and 200_i (i=1, 2, 3) may include hardware not shown in FIG. 6.

As shown in FIG. 6, the hardware configuration 10 that may be employed by the secure computation server apparatuses 100_i and 200_i (i=1, 2, 3) comprises a CPU (Central Processing Unit) 11, a primary storage device 12, an auxiliary storage device 13, and an IF (interface) part 14. These elements are connected to each other by, for instance, an internal bus.

The CPU 11 executes each instruction included in the secure computation program executed by the secure computation server apparatuses 100_i and 200_i (i=1, 2, 3). The primary storage device 12 is, for instance, a RAM (Random Access Memory) and temporarily stores various programs such as the secure computation program executed by the secure computation server apparatuses 100_i and 200_i (i=1, 2, 3) so that the CPU 11 can process the programs.

The auxiliary storage device 13 is, for instance, an HDD (Hard Disk Drive) and is capable of storing the various programs, such as the secure computation program executed by the secure computation server apparatuses 100_i and 200_i (i=1, 2, 3), in the medium to long term. The various programs such as the secure computation program may be provided as a program product stored in a non-transitory computer-readable storage medium. The auxiliary storage device 13 can be used to store the various programs such as the secure computation program stored in the non-transitory computer-readable storage medium in the medium to long term. The IF part 14 provides an interface to the input and output between the secure computation server apparatuses 100_i and 200_i (i=1, 2, 3).

The information processing apparatus employing the hardware configuration 10 described above can achieve the functions of the secure computation server apparatuses 100_i and 200_i (i=1, 2, 3) by executing the secure computation method described above as a secure computation program.

Some or all of the example embodiments above can be described as (but not limited to) the following Supplementary Notes.

### [Supplementary Note 1]

A secure computation system comprising at least three secure computation server apparatuses connected to each other via a network and extracting the most significant bit of an input value stored while being secret-shared, wherein
each of the secure computation server apparatuses comprises:
a random number generation part that generates a random number for masking the input value;
an m-1 bit comparison part that compares a value obtained by removing the most significant bit from the input value masked with the random number with a value obtained by removing the most significant bit from the random number;
a carry correction part that corrects the calculation of a value obtained by removing the most significant bit from the input value on the basis of the result of the comparison; and
a most significant bit extraction part that extracts the most significant bit of the input value by subtracting the corrected value of the value obtained by removing the most significant bit from the input value from the input value.

### [Supplementary Note 2]

The secure computation system according to Supplementary Note 1, wherein the cost of the communication performed among the secure computation server apparatuses for the comparison performed by the m-1 bit comparison part is constant rounds.

### [Supplementary Note 3]

The secure computation system according to Supplementary Note 2, wherein the total cost of the communication performed among the secure computation server apparatuses for the processes performed by the m-1 bit comparison part, the carry correction part, and the most significant bit extraction part is constant rounds.

### [Supplementary Note 4]

The secure computation system according to any one of Supplementary Notes 1 to 3, wherein the random number generation part does not depend on the input value, and each of the secure computation server apparatuses independently performs processing.

### [Supplementary Note 5]

The secure computation system according to any one of Supplementary Notes 1 to 4, wherein the carry correction part corrects the calculation of a value obtained by removing the most significant bit from the input value when a value obtained by removing the most significant bit from the random number is greater than a value obtained by removing the most significant bit from the input value masked with the random number.

### [Supplementary Note 6]

A secure computation server apparatus out of at least three secure computation server apparatuses, connected to each other via a network, for extracting the most significant bit of an input value stored while being secret-shared, the secure computation server apparatus comprising:
a random number generation part that generates a random number for masking the input value;
an m-1 bit comparison part that compares a value obtained by removing the most significant bit from the input value masked with the random number with a value obtained by removing the most significant bit from the random number;
a carry correction part that corrects the calculation of a value obtained by removing the most significant bit from the input value on the basis of the result of the comparison; and
a most significant bit extraction part that extracts the most significant bit of the input value by subtracting the corrected the value of the value obtained by removing the most significant bit from the input value from the input value.

### [Supplementary Note 7]

A secure computation method for extracting the most significant bit of an input value stored while being secret-shared using at least three secure computation server apparatuses connected to each other via a network, the secure computation method comprising:
a random number generation of generating a random number for masking the input value;
an m-1 bit comparison of comparing a value obtained by removing the most significant bit from the input value masked with the random number with a value obtained by removing the most significant bit from the random number;
a carry correction of correcting a value obtained by removing the most significant bit from the input value on the basis of the result of the comparison; and
a most significant bit extraction of extracting the most significant bit of the input value by subtracting the corrected value of the value obtained by removing the most significant bit from the input value from the input value.

### [Supplementary Note 8]

The secure computation method according to Supplementary Note 7, wherein the random number generation does not depend on the input value, and each of the secure computation server apparatuses independently performs the processing.

### [Supplementary Note 9]

The secure computation method according to Supplementary Note 7 or 8, wherein the carry correction corrects the calculation of a value obtained by removing the most significant bit from the input value when a value obtained by removing the most significant bit from the random number is greater than a value obtained by removing the most significant bit from the input value masked with the random number.

### [Supplementary Note 10]

A secure computation program causing at least three secure computation server apparatuses connected to each other via a network to extract the most significant bit of an input value stored while being secret-shared, the secure computation program comprising:
a random number generation of generating a random number for masking the input value;
an m-1 bit comparison of comparing a value obtained by removing the most significant bit from the input value masked with the random number with a value obtained by removing the most significant bit from the random number;
a carry correction of correcting the calculation of a value obtained by removing the most significant bit from the input value on the basis of the result of the comparison; and
a most significant bit extraction of extracting the most significant bit of the input value by subtracting the corrected value of the value obtained by removing the most significant bit from the input value from the input value.

Further, the disclosure of each Non-Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object of the present invention shall be considered to be included in the disclosed matters of the present application.

### REFERENCE SIGNS LIST

100, 200: secure computation system
100_i, 200_i: secure computation server apparatus
101_i: random number generation part
102_i: m-1 bit comparison part
103_i: carry correction part
104_i: most significant bit extraction part
10: hardware configuration
11: CPU (Central Processing Unit)
12: primary storage device
13: auxiliary storage device
14: IF (interface) part

What is claimed is:

1. A secure computation system comprising at least three secure computation server apparatuses connected to each other via a network and extracting the most significant bit of an input value stored while being secret-shared, wherein
each of the secure computation server apparatuses comprises:
a random number generation part that generates a random number for masking the input value;
an m-1 bit comparison part that compares a value obtained by removing the most significant bit from the input value masked with the random number with a value obtained by removing the most significant bit from the random number;
a carry correction part that corrects the calculation of a value obtained by removing the most significant bit from the input value on the basis of the result of the comparison; and
a most significant bit extraction part that extracts the most significant bit of the input value by subtracting the corrected value of the value obtained by removing the most significant bit from the input value from the input value.

2. The secure computation system according to claim 1, wherein the cost of the communication performed among the secure computation server apparatuses for the comparison performed by the m-1 bit comparison part is constant rounds.

3. The secure computation system according to claim 2, wherein the total cost of the communication performed among the secure computation server apparatuses for the processes performed by the m-1 bit comparison part, the carry correction part, and the most significant bit extraction part is constant rounds.

4. The secure computation system according to claim 1, wherein the random number generation part does not depend on the input value, and each of the secure computation server apparatuses independently performs processing.

5. The secure computation system according to claim 1, wherein the carry correction part corrects the calculation of a value obtained by removing the most significant bit from the input value when a value obtained by removing the most significant bit from the random number is greater than a value obtained by removing the most significant bit from the input value masked with the random number.

6. A secure computation server apparatus out of at least three secure computation server apparatuses, connected to each other via a network, for extracting the most significant bit of an input value stored while being secret-shared, the secure computation server apparatus comprising:
a random number generation part that generates a random number for masking the input value;
an m-1 bit comparison part that compares a value obtained by removing the most significant bit from the input value masked with the random number with a value obtained by removing the most significant bit from the random number;
a carry correction part that corrects the calculation of a value obtained by removing the most significant bit from the input value on the basis of the result of the comparison; and
a most significant bit extraction part that extracts the most significant bit of the input value by subtracting the corrected value of the value obtained by removing the most significant bit from the input value from the input value.

7. A secure computation method for extracting the most significant bit of an input value stored while being secret-shared using at least three secure computation server apparatuses connected to each other via a network, the secure computation method comprising:
a random number generation of generating a random number for masking the input value;
an m-1 bit comparison of comparing a value obtained by removing the most significant bit from the input value masked with the random number with a value obtained by removing the most significant bit from the random number;
a carry correction of correcting a value obtained by removing the most significant bit from the input value on the basis of the result of the comparison; and
a most significant bit extraction of extracting the most significant bit of the input value by subtracting the corrected value of the value obtained by removing the most significant bit from the input value from the input value.

8. The secure computation method according to claim 7, wherein the random number generation step-does not depend on the input value, and each of the secure computation server apparatuses independently performs processing.

9. The secure computation method according to claim 7, wherein the carry correction corrects the calculation of a value obtained by removing the most significant bit from the input value when a value obtained by removing the most significant bit from the random number is greater than a value obtained by removing the most significant bit from the input value masked with the random number.

10. A non-transient computer readable medium storing a secure computation program causing at least three secure computation server apparatuses connected to each other via a network to extract the most significant bit of an input value stored while being secret-shared, the secure computation program comprising:
a random number generation of generating a random number for masking the input value;
an m-1 bit comparison of comparing a value obtained by removing the most significant bit from the input value masked with the random number with a value obtained by removing the most significant bit from the random number;
a carry correction of correcting the calculation of a value obtained by removing the most significant bit from the input value on the basis of the result of the comparison; and
a most significant bit extraction of extracting the most significant bit of the input value by subtracting the corrected value of the value obtained by removing the most significant bit from the input value from the input value.

11. The secure computation server apparatus according to claim 6, wherein the cost of the communication performed among the secure computation server apparatuses for the comparison performed by the m-1 bit comparison part is constant rounds.

12. The secure computation server apparatus according to claim 11, wherein the total cost of the communication performed among the secure computation server apparatuses for the processes performed by the m-1 bit comparison part, the carry correction part, and the most significant bit extraction part is constant rounds.

13. The secure computation server apparatus according to claim 6, wherein the random number generation part does not depend on the input value, and each of the secure computation server apparatuses independently performs processing.

14. The secure computation server apparatus according to claim 6, wherein the carry correction part corrects the calculation of a value obtained by removing the most significant bit from the input value when a value obtained by removing the most significant bit from the random number is greater than a value obtained by removing the most significant bit from the input value masked with the random number.

15. The secure computation method according to claim 7, wherein the cost of the communication performed among the secure computation server apparatuses for the comparison in the m-1 bit comparison is constant rounds.

16. The secure computation method according to claim 15, wherein the total cost of the communication performed among the secure computation server apparatuses for the processes in the m-1 bit comparison, the carry correction part, and the most significant bit extraction part is constant rounds.

17. The non-transient computer readable medium storing the program according to claim 10, wherein the random number generation does not depend on the input value, and each of the secure computation server apparatuses independently performs processing.

18. The non-transient computer readable medium storing the program according to claim 10, wherein the carry correction corrects the calculation of a value obtained by removing the most significant bit from the input value when a value obtained by removing the most significant bit from the random number is greater than a value obtained by removing the most significant bit from the input value masked with the random number.

19. The non-transient computer readable medium storing the program according to claim 10, wherein the cost of the communication performed among the secure computation server apparatuses for the comparison in the m-1 bit comparison is constant rounds.

20. The non-transient computer readable medium storing the program according to claim 19, wherein the total cost of the communication performed among the secure computation server apparatuses for the processes in the m-1 bit comparison, the carry correction part, and the most significant bit extraction part is constant rounds.
